(19) United States
(12) Patent Application Publication
(10) Pub. No.: US 2025/0308791 A1
(43) Pub. Date: Oct. 2, 2025

(54) MULTILAYER CERAMIC CAPACITOR AND CIRCUIT BOARD

(71) Applicant: TAIYO YUDEN CO., LTD., Tokyo (JP)

(72) Inventors: Takeshi SAKASHITA, Tokyo (JP); Yoshinari TAKE, Tokyo (JP); Tomoki INOUE, Tokyo (JP); Takayuki TAKANO, Tokyo (JP); Yuka NAITO, Tokyo (JP)

(73) Assignee: TAIYO YUDEN CO., LTD., Tokyo (JP)

(21) Appl. No.: 19/084,852

(22) Filed: Mar. 20, 2025

(30) Foreign Application Priority Data
Mar. 27, 2024 (JP) 2024-050663

(51) Int. Cl. H01G 4/232; H01G 2/06; H01G 4/008; H01G 4/012; H01G 4/224; H01G 4/30

(52) U.S. Cl. CPC H01G 4/232; H01G 2/065; H01G 4/008; H01G 4/012; H01G 4/224; H01G 4/30

(57) ABSTRACT

One aspect of the present invention is a multilayer ceramic capacitor, including: a cuboid element body having a stack formed with alternating ceramic layers and internal electrodes made primarily of metal, a protective portion covering a surface of the stack, and a plurality of via conductors arranged so as to pass through the ceramic layers in the stacking direction of the stack, electrically connected to the internal electrodes, and having one end reaching the surface of the protective portion while the other end is positioned in the protective portion, and a plurality of terminal electrodes arranged on the surface of the element body and electrically connected to the end of each via conductor reaching the surface of the protective portion, wherein the ends of the via conductors positioned in the protective portion form a flange that extends outwardly relative to the axis of the via conductor.

### CROSS-REFERENCE TO RELATED APPLICATIONS

This application claims the benefit of Japanese Application No. 2024-050663, filed Mar. 27, 2024, in the Japanese Patent Office. All disclosures of the document named above is incorporated herein by reference.

### 1. Field of the Invention

Aspects of the present invention relate to a multilayer ceramic capacitor and a circuit board.

### 2. Description of the Related Art

A wide variety of ceramic electronic components are used in high-frequency communication systems, such as in mobile phones. There is a demand for smaller and thinner ceramic electronic components, and multilayer ceramic capacitors are being considered to reduce the size and thickness of these components.

Patent document 1 discloses a multilayer ceramic capacitor that can improve ESL characteristics and fill factor as well as reduce delamination. Patent Document 1 states that the phenomenon of the cover being pressed against by external forces can be prevented and the ESL characteristics improved by including a taper with a trapezoidal cross section in through-hole electrodes that pass through the body of the multilayer ceramic capacitor. Patent Document 1 also states that via paste fillability can be improved and the fill rate increased by adjusting the diameter of the through-hole electrodes.

### Prior Art Documents

### Patent Documents

### Patent Document 1

### JP 2021-13008 A

### SUMMARY OF THE INVENTION

### Problem to Be Solved by the Invention

In Patent Document 1, the through-hole electrodes (via conductors) have a shape whose diameter increases monotonically from the bottom end to the top end. In a multilayer ceramic capacitor with via conductors using such a shape, delamination at the interface between via conductors and ceramic layers and at the interface between via conductors and internal electrodes is suppressed, and reduction in electrostatic capacitance due to the breakdown in connections between via conductors and internal electrodes due to the delamination is suppressed. However, further suppression of delamination and capacitance degradation is required.

In contrast to Patent Document 1, in a multilayer ceramic capacitor in which external electrodes (terminal electrodes) are formed only on either the first or second main surface, in firing during manufacturing, the stress caused by the difference in shrinkage behavior between the via conductors and the terminal electrodes causes delamination at the interface between the via conductors and the internal electrodes, and the connection between the two is easily broken, inducing a drop in capacitance.

It is an object of the present invention to solve this problem by providing a thin multilayer ceramic capacitor with suppressed electrostatic capacitance degradation, and a circuit board carrying this multilayer ceramic capacitor.

### Means for Solving the Problem

As a result of extensive research conducted to solve this problem, the present inventors discovered that this object could be realize in a multilayer ceramic capacitor in which internal electrodes are electrically connected to each other with via conductors, by forming the via conductors with one end reaching the surface of the protective portion and the other end being located inside the protective portion, and forming a flange that extends outward relative to the axis of the via conductors at the end located in the protective portion. The present invention is a product of this discovery.

Specifically, a first aspect of the present invention that solves this problem is a multilayer ceramic capacitor, comprising: a cuboid element body having a stack formed with alternating ceramic layers and internal electrodes made primarily of metal, a protective portion covering a surface of the stack, and a plurality of via conductors arranged so as to pass through the ceramic layers in the stacking direction of the stack, electrically connected to the internal electrodes, and having one end reaching the surface of the protective portion while the other end is positioned in the protective portion, and a plurality of terminal electrodes arranged on the surface of the element body and electrically connected to the end of each via conductor reaching the surface of the protective portion, wherein the ends of the via conductors positioned in the protective portion form a flange that extends outwardly relative to the axis of the via conductor.

A second aspect of the present invention that solves this problem is a circuit board carrying the multilayer ceramic capacitor according to the first aspect.

### Effect of the Invention

The present invention is able to provide a thin multilayer ceramic capacitor with suppressed electrostatic capacitance degradation, and a circuit board carrying this multilayer ceramic capacitor.

Additional aspects and/or advantages of the invention will be set forth in part in the description which follows and, in part, will be obvious from the description, or may be learned by practice of the invention.

### BRIEF DESCRIPTION OF THE DRAWINGS

FIG. 1 is a schematic diagram (perspective view) showing the configuration of the multilayer ceramic capacitor in the first embodiment of the present invention.

FIG. 2 is a cross-sectional view (LT cross-sectional view) from A-A in FIG. 1.

FIG. 3 is a diagram used to explain the step for determining that the end portion of a via conductor located in the protective (cover) portion forms a flange, and the step for determining the dimensions of each portion of the via conductor.

FIG. 4 is a schematic diagram (LT cross-sectional view) showing the structure of a multilayer ceramic capacitor provided with via conductors having a cavity opening at the end portion located in the protective portion (cover portion).

FIG. 5 is a diagram used to explain the step for determining the dimensions of the cavity formed in the end portion of the via conductor located in the cover portion.

FIG. 6 is a schematic diagram (LT cross-sectional view) showing the structure of a multilayer ceramic capacitor provided with via conductors having a shape in which the central portion of the end portion located in the protective portion (cover portion) is bulging.

FIG. 7 is a schematic diagram (LT cross-sectional view) showing the structure of a multilayer ceramic capacitor in which the end portion of the via conductors reaching the mounting face protrudes in the stacking direction beyond the surface of the mounting face and forms a flange that extends outward relative to the axis of the via conductor.

FIG. 8 is a diagram used to explain the step for determining that a flange has been formed at the mounting face end of a via conductor, and the step for determining the dimensions of the flange.

FIG. 9 is a schematic diagram (LT cross-sectional view) showing the configuration of the multilayer ceramic capacitor in the second embodiment of the present invention.

FIG. 10 is a schematic diagram (perspective view) showing the configuration of the multilayer ceramic capacitor in the third embodiment of the present invention.

### DETAILED DESCRIPTION OF THE EMBODIMENTS

The configuration and effects of the present invention will now be explained with technical concepts and with reference to the drawings, wherein like reference numerals refer to the like elements throughout. The mechanism of action includes conjecture, but correctness or incorrectness of this conjecture does not limit the present invention.

### Multilayer Ceramic Capacitor

### First Embodiment

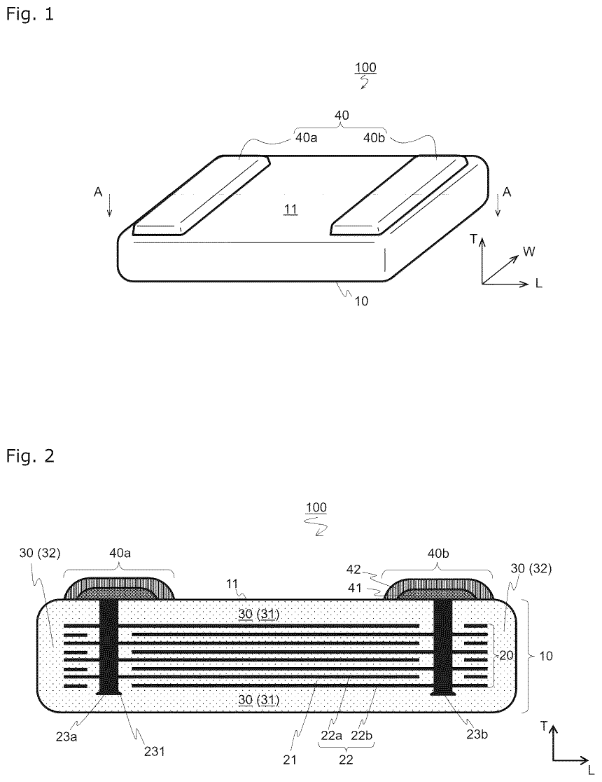

An embodiment of a multilayer ceramic capacitor related to the first aspect of the present invention is shown in FIG. 1 and FIG. 2 as the first embodiment. The multilayer ceramic capacitor 100 in the first embodiment has a cuboid shape and has a pair of planes that are orthogonal to each other on three mutually orthogonal axes, namely, the L-axis, which is the length direction, the W-axis, which is the width direction, and the T-axis, which is the height direction. The cuboid is not limited to a cuboid shape defined mathematically, but can be any shape that is recognized as being cuboid when the overall shape is observed. For this reason, objects with rounded edges and corners, curved edges, and surfaces with a small degree of curvature also fall under the category of “cuboid” in the present disclosure. The length (L), width (W), and height (T) dimensions of the ceramic capacitor 100 can each independently take any value.

In an example of dimensions for a multilayer ceramic capacitor 100, the L-direction dimension is 200 μm or more and 2000 μm or less, the W-direction dimension is 100 μm or more and 2000 μm or less, the T-direction dimension is 30 μm or more and 220 μm or less, and the W/L value, which is the ratio of the W-direction dimension to the L-direction dimension, is 0.3 or more and 1.0 or less. Preferably, the L-direction dimension is 400 μm or more and 1200 μm or less, the W-direction dimension is 400 μm or more and 1200 μm or less, the T-direction dimension is 40 μm or more and 150 μm or less, and the W/L value, which is the ratio of the W-direction dimension to the L-direction dimension, is 0.4 or more and 1.0 or less. A T-direction dimension of 100 μm or less is preferred in that it is less likely to impose design constraints on the circuit board on which it is mounted.

In the multilayer ceramic capacitor 100 of the first embodiment, as shown schematically in cross-sectional view in FIG. 2 (LT cross-sectional view), the element body 10 has ceramic layers 21, internal electrodes 22 made primarily of metal, which are alternately stacked in the T direction to form a stack 20, and a protective portion 30 that covers the surfaces of the stack 20. The internal electrodes 22 include internal electrodes 22a of one polarity that are electrically connected to each other, and internal electrodes 22b of a different polarity than internal electrodes 22a that are electrically connected to each other.

On the surfaces of the element body 10, a protective portion 30 is arranged to cover the surfaces of the stack 20. The protective portion 30 includes a cover portion 31 arranged on a plane perpendicular to the T direction, and margin portions 32 arranged on planes perpendicular to the W and L directions.

The element body 10 has a plurality of via conductors 23 arranged so as to pass through the ceramic layers 21 in the stacking direction of the stack 20 and connect electrically to internal electrodes 22, with one end reaching the surface of the protective portion 30 (cover portion 31) and the other end located in the protective portion 30 (cover portion 31). The via conductors 23 include via conductor 23a electrically connected to internal electrodes 22a and via conductor 23b electrically connected to internal electrodes 22b. The multilayer ceramic capacitor 100 shown in FIG. 1 and FIG. 2 has two via conductors 23, but the number of via conductors in the multilayer ceramic capacitor of the first aspect of the invention is not limited to this example.

The end portion located in the cover portion 31 of the via conductor 23 (23a, 23b) forms a flange 231 that extends outwardly relative to the axis of the via conductor 23 (23a, 23b). This prevents delamination at the interface between the via conductor (23a, 23b) and the internal electrodes 22 (22a, 22b), and prevents a decrease in the capacitance of the multilayer ceramic capacitor 100. This is probably because the presence of the flange 231 causes the via conductor 23 to conform and become displaced in the same direction as the stack 20 when it is displaced in the stack direction. The shape and structure of the via conductors 23 (23a, 23b) will be described in detail below.

The multilayer ceramic capacitor 100 in the first embodiment has a plurality of terminal electrodes 40 electrically connected to via conductors 23 (23a, 23b), which are located at least on the mounting face 11, which is the face opposite to the circuit board when the multilayer ceramic capacitor is mounted on the circuit board, among the faces forming the surface of the element body 10. The terminal electrodes 40 include terminal electrode 40a electrically connected to via conductor 23a and terminal electrode 40b electrically connected to via conductor 23b. The multilayer ceramic capacitor 100 shown in FIG. 1 and FIG. 2 has two terminal electrodes 40, but the number of terminal electrodes in the multilayer ceramic capacitor in the first aspect of the invention is not limited to this example.

The thickness of the element body 10, which is obtained by subtracting the thickness of the terminal electrodes 40 (40a, 40b) from the T-direction dimension of the multilayer ceramic capacitor 100, is, for example, 20 μm or more and 200 μm or less, and preferably 30 μm or more and 180 μm or less.

The following is a detailed description of each component that constitutes the multilayer ceramic capacitor 100 in the first embodiment.

### Ceramic Layers

The ceramic layers 21 are formed of a ceramic. The composition of the ceramic is not particularly limited, as long as it forms a dense ceramic layer 21 during simultaneous firing with the internal electrodes 22 described below, and can be selected as appropriate depending on the characteristics required of the multilayer ceramic capacitor. Examples of ceramic compositions include those with barium titanate (BaTiO₃) as the main component, those with strontium titanate (SrTiO₃) as the main component, and those with a perovskite-type structure Ba_{1-x-y}CaₓSr_{y}Ti_{1-z}Zr_{z}O₃ as the main component. The ceramic may contain additive elements in addition to the main components mentioned above. Examples of additive elements include at least one selected from Mo, Nb, Ta, W, Mg, Mn, V, and Cr, rare earth elements (Y, Sm, Eu, Gd, Tb, Dy, Ho, Er, Tm, and Yb), and Co, Ni, Li, B, Na, K, and Si. The additive element may be included in the form of a compound, such as an oxide, nitride, or carbide, or it may be included as the element in its pure form. In addition, the additive elements may be present in a solid solution with the main component mentioned above, or may form a different phase with the element that constitutes the main component or another additive element.

### Internal Electrodes

The internal electrodes 22 (22a, 22b) are composed primarily of metal. There are no particular restrictions on the type of metal, and nickel (Ni), copper (Cu), palladium (Pd), platinum (Pt), silver (Ag), gold (Au), or alloys of these metals can be used. Among these, those with nickel (Ni) as the main component element are preferred because of their high heat resistance, which allows the firing temperature to be increased during firing together with the ceramic layers 21 to form dense ceramic layers 21, and because they are relatively inexpensive. In this document, the term “main component element” refers to the element with the highest content, expressed as an atomic percentage (at %).

In addition to metal, the internal electrodes 22 (22a, 22b) may also contain ceramic particles having a composition similar to that of the ceramic that constitutes the ceramic layers 21, or glass components.

### Protective Portion

The protective portion 30 has the function of protecting the ceramic layers 21 and internal electrodes 22. The material in the protective portion 30 is not limited as long as it has high electrical insulation properties and low permeability to moisture and other degradation factors. From the standpoint of ensuring uniform shrinkage during firing when manufacturing the multilayer ceramic capacitor 100, and relieving internal stress inside the multilayer ceramic capacitor 100, the main component of the protective portion 30 is preferably the same as the ceramic forming the ceramic layers 21.

### Via Conductors

Like the internal electrodes 22 (22a, 22b), the via conductors 23 (23a, 23b) are made primarily of metal. The metals that can be used are the same as those used in the internal electrodes 22 (22a, 22b) mentioned above. The composition of the via conductors may be different from that of the internal electrodes 22 (22a, 22b), but is preferably the same as that of the internal electrodes 22 (22a, 22b). By making the composition of the via conductors (23a, 23b) and the internal electrode 22 (22a, 22b) the same, the degree of shrinkage caused by firing during the manufacture of the multilayer ceramic capacitor 100 is uniform, which helps to suppress deformation, and the resistivity of the conductive paths of the multilayer ceramic capacitor 100 is uniform, which helps to suppress localized heat generation during use.

As mentioned above, one end of a via conductor 23 (23a, 23b) reaches the surface of the protective portion 30 (cover portion 31) and the other end is located inside the protective portion 30 (cover portion 31). The end portion located inside the protective portion 30 (cover portion 31) forms a flange 231 that extends outward relative to the axis of the via conductor 23 (23a, 23b).

A preferred shape of the via conductor 23 (23a, 23b) satisfies D1>D2, where D1 is the dimension perpendicular to the stacking direction at the surface of the protective portion 30 (cover portion 31) in a cross-section parallel to the stacking direction, and D2 is the minimum dimension in the direction perpendicular to the stacking direction inside the protective portion 30 (cover portion 31), which is located at the opposite side of the protective portion 30 (cover portion 31) in the stack 20 and the end portion of the via conductor 23 (23a, 23b) is located inside, and the dimension in the direction perpendicular to the stacking direction preferably decreases monotonically from D1 to D2. This increases suppression of delamination at the interface between the via conductor 23 (23a, 23b) and the internal electrodes 22 (22a, 22b), which further suppresses the capacitance drop in the multilayer ceramic capacitor 100. This is probably because D1 approaches the dimensions of the terminal electrode 40, as discussed below, the shrinkage behavior of the via conductor 23 (23a, 23b) approaches that of the terminal electrode 40, and the via conductors 23 (23a, 23b) exhibit a tapered shape. This increases contact area between the stack 20 and the cover portion 31 as well as the frictional resistance.

Here, when the via conductor 23 (23a, 23b) satisfies D3≥D1, where D3 is the dimension of the flange 231 perpendicular to the stacking direction in a cross-section parallel to the stacking direction, suppression of delamination at the interface between the via conductor 23 (23a, 23b) and the internal electrodes 22 (22a, 22b) is greater, and the decrease in capacitance of the multilayer ceramic capacitor 100 is further suppressed. This is probably because the larger dimension of the flange 231 perpendicular to the stacking direction significantly increases the resistance force when the via conductor 23 (23a, 23b) is displaced in the stacking direction.

Although the values for D1, D2 and D3 are not particularly limited, from the standpoint of reducing electrical resistance and suppressing heat generation during circuit operation while securing the capacitance of the multilayer ceramic capacitor 100, the value of D2 is preferably 5 μm or more and 100 μm or less, and more preferably 10 μm or more and 50 μm or less. Also, the value of D3 is preferably 110% or more and 225% or less of the value of D2, and more preferably 150% or more and 180% or less. In addition, the value of D3 is preferably 100% or more and 150% or less of the value of D1, and more preferably 100% or more and 120% or less.

The via conductor 23 (23a, 23b) preferably has a dimension in the stacking direction for the flange 231, that is, a thickness A1 for the flange 231, of 0.1 μm or more and 10 μm or less. When the thickness of flange 231 is 0.1 μm or more, sufficient resistance can be ensured to suppress the displacement of via conductor 23 (23a, 23b) in the stacking direction. Meanwhile, when the thickness of flange 231 is 10 μm or less, the distance from the surface of element body 10 and internal electrodes 22 to the via conductor 23 (23a, 23b) is sufficient to ensure reliability of the multilayer ceramic capacitor.

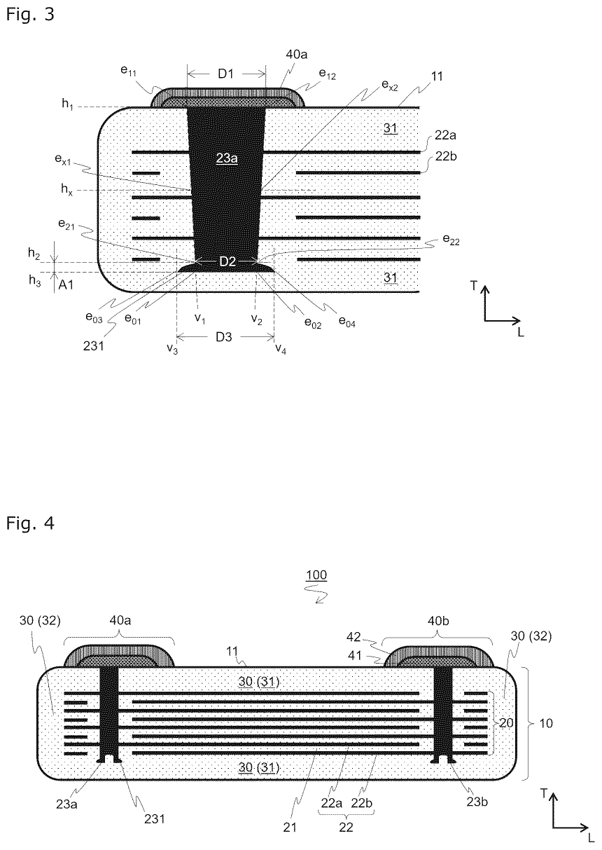

The following process is used to determine whether an end portion of a via conductor 23 (23a, 23b) located inside the protective portion 30 forms a flange 231, and to determine dimensions D1, D2, D3 and A1 of each component of the via conductor 23 (23a, 23b). First, the face of the multilayer ceramic capacitor 100 orthogonal to the mounting face 11, which is the face opposite to a circuit board when mounted on the circuit board, is polished to expose the vicinity of the center of gravity of the via conductor 23a. Polishing may be performed on a multilayer ceramic capacitor 100 embedded in resin. Next, the polished surface where the via conductor 23a is exposed is inspected using an optical microscope or scanning electron microscope (SEM) to obtain an image of the interface between the via conductor 23a and the ceramic layers 21, as well as the mounting face 11 and the opposite face, in the same field of view, as shown in FIG. 3. Next, in the acquired image, line segments V1 and V2 are drawn that define both sides of the via conductor 23a in the stack 20 and the intersection points of the two line segments with the end portion of the via conductor 23a located inside the cover section 31 established as e₀₁ and e₀₂. It is determined whether the end portion of the via conductor 23a located inside the cover portion has formed a flange 231 by the fact that the outside edge is located outward from the axis of the via conductor 23a beyond points e₀₁ and e₀₂. At this time, the point on the end portion farthest from the axis of the via conductor 23a on the point e₀₁ side is e₀₃, and the point on the end portion farthest from the axis of the via conductor 23a on the point e₀₂ side is e₀₄. Next, in the image, the line segment h₁ defining the mounting face 11 is drawn, and the intersection points of the line segment with line segment v₁ and line segment v₂ are e₁₁ and e₁₂, respectively. The value obtained by dividing the distance between points e₁₁ and e₁₂ by the magnification factor of the microscopic image is D1. Next, in the above image, line segment v₃ perpendicular to line segment h₁ passing through point e₀₃ and line segment v₄ perpendicular to line segment h₁ passing through point e₀₄, are drawn, and the distance between line segments v₃ and v₄ is divided by the magnification factor of the microscopic image to obtain D3. Next, line segments parallel to line h₁ are drawn in the cover portion 31 where the end portion of the via conductor 23a is located inside, the one that has the smallest distance between intersection points with both sides of the via conductor 23a is set as line segment h₂, and the intersection points are set as e₂₁ and e₂₂. The distance between points e₂₁ and e₂₂ is then divided by the magnification factor of the microscopic image, and the resulting value is D2. At this time, it is determined whether the dimension of the via conductor 23a in the direction perpendicular to the stacking direction monotonically decreases from D1 to D2 when as line segment hₓ parallel to line segment h₁ approaches point e₂₁ and point e₂₂ from point e₁₁ and point e₁₂, the distance between the intersection eₓ₁ of the line segment hₓ and the line segment v₁, and the intersection eₓ₂ of the line segment hₓ and the line segment v₂, that, is the length of the line segment eₓ₁eₓ₂, is reduced. Next, in the image, a line segment h₃ is drawn that is parallel to line segment h₁, contacts the end portion of the via conductor 23a located inside the cover portion 31, and has the greatest distance from line segment h₂, and the value obtained by dividing the distance between line segment h₃ and line segment h₂ by the magnification factor of the microscopic image is A1. When drawing the line segments v₁, v₂, and h₁, if the side surface of the via conductor 23a and the mounting face 11 observed in the image form a curved line or polyline, the curved line or polyline is linearly approximated as a line segment. Although this process was performed in the vicinity of via conductor 23a, it goes without saying that it may also be performed in the vicinity of via conductor 23b, which has a different polarity.

The via conductor 23 (23a, 23b), as shown in FIG. 4, preferably has a cavity opening in the end portion located inside the protective portion 30 (cover portion 31). This suppresses delamination at the interface between the via conductor 23 (23a, 23b) and the cover portion 31 where the cover portion 31 includes the end portion of the via conductor 23 (23a, 23b) inside. This is probably because the presence of the cavity reduces the contact area between the via conductor 23 (23a, 23b) and the cover portion 31, and the stress generated at the interface between them due to the difference in shrinkage between the via conductor 23 (23a, 23b) and the cover portion 31 during firing in the manufacturing process is reduced.

In the cavity formed in the end portion of the via conductor 23 (23a, 23b) located inside the cover portion 31, the maximum dimension D4 in the direction perpendicular to the stacking direction is more preferably 10% or more and 90% or less of D2, that is, the minimum dimension in the direction perpendicular to the stacking direction of the portion located inside the cover portion 31. When D4 is 10% or more of D2, delamination at the interface between the via conductor 23 (23a, 23b) and the cover portion 31 is significantly suppressed. Meanwhile, when D4 is 90% or less of D2, sufficient resistance to displacement of the via conductor 23 (23a, 23b) in the stacking direction is provided while delamination at the interface between the via conductor 23 (23a, 23b) and the internal electrodes 22 (22a, 22b) can be suppressed.

Maximum dimension A2 in the stacking direction of the cavity formed in the end portion of the via conductor 23 (23a, 23b) located inside the cover portion 31 is preferably 1 μm or more and 20 μm or less, more preferably 1 μm or more and 10 μm or less, and even more preferably 1 μm or more and 5 μm or less. When A2 is 1 μm or more, delamination at the interface between the via conductor 23 (23a, 23b) and the cover portion 31 is significantly suppressed. Meanwhile, when A2 is 10 μm or less, sufficient resistance to displacement of the via conductor 23 (23a, 23b) in the stacking direction and the direction perpendicular to the stacking direction is provided while delamination at the interface between the via conductor 23 (23a, 23b) and the internal electrodes 22 (22a, 22b) can be suppressed.

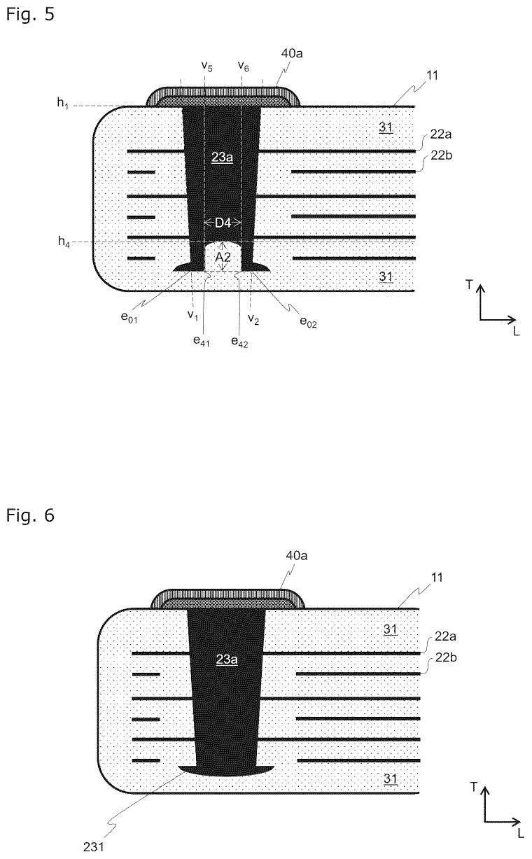

Dimensions D4 and A2 of each portion in the cavity formed in the end portion of the via conductor 23 (23a, 23b) located inside the cover portion 31 are determined using the following process. First, using the same process to determine D1, D2, D3, and A1 above, an image is obtained of the interface between the via conductor 23a and the ceramic layers 21, as well as the mounting face 11 and the opposite face in the same field of view, as shown in FIG. 5, and line segment v₁ and point e₀₁, line segment v₂ and point e₀₂, and line segment h₁ are drawn in the image. Next, in the image, line segment e₀₁e₀₂ is drawn connecting point e₀₁ and point e₀₂, and among the points along the line segment intersecting the contour line of the via conductor 23a defining the cavity in the end portion of the via conductor 23a located inside the cover portion 31, the one closer to point e₀₁ is set as e₄₁ and the one closer to point e₀₂ is set as e₄₂. If point e₄₁ does not exist at this time, point e₀₁ is treated as point e₄₁ in subsequent steps, and if point e₄₂ does not exist at this time, point e₀₂ is treated as point e₄₂ in subsequent steps. Next, in the image, line segment v₅ perpendicular to line segment h₁ passing through point e₄₁ and line segment v₅ perpendicular to line segment h₁ passing through point e₄₂ are drawn, and the value obtained by dividing the distance between line segment v₅ and line segment v₆ by the magnification factor of the microscopic image is set as D4. Next, in the image, a line segment h₄ is drawn that is parallel to line segment h₁, contacts the contour line of the via conductor 23a that defines the cavity, and has the greatest distance from line e₀₁e₀₂. The value obtained by dividing the shortest distance between line segment h₄ and line segment e₀₁e₀₂ by the magnification factor of the microscopic image is set as A2.

The end portion of the via conductor 23 (23a, 23b) located inside the protective portion 30 (cover portion 31) may, contrary to the cavity described above, have a shape with a bulging center, that is, a protruding portion protruding in the stacking direction of the stack 20, as shown in FIG. 6. Such a shape is formed as a result of the via conductor forming conductive paste staying put without moving to the mounting face 11 and pushing back the green sheet for forming the cover portion when the green sheet for forming the cover part is pressed during the multilayer ceramic capacitor 100 manufacturing process, which is to be described later. Therefore, the bulge in the central portion on the end portion of the via conductor 23 (23a, 23b) located in the cover portion 31 indicates high adhesion between the via conductor 23 (23a, 23b) and the adjacent cover portion 31, ceramic layer 21, and internal electrodes 22 (22a, 22b), and results in a multilayer ceramic capacitor 100 with high mechanical strength.

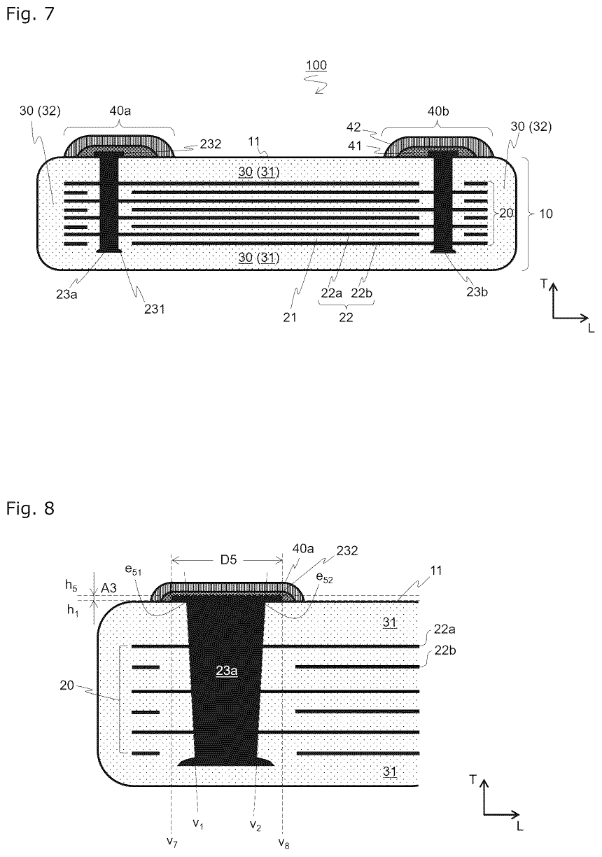

In a via conductor 23 (23a, 23b), the end portion reaching the surface of the protective portion 30 (cover portion 31) preferably protrudes in the stacking direction beyond the surface of the cover portion 31, that is, the mounting face 11, and has a flange 232 that extends outward relative to the axis of the via conductor 23 (23a, 23b), as shown in FIG. 7. This suppresses delamination at the interface between the via conductor 23 (23a, 23b) and the cover portion 31 in the cover section 31 where the via conductor 23 (23a, 23b) reaches the surface. This is probably due to the fact that the action of the flange 232 in contact with the surface of the cover portion 31 causes the via conductor 23 (23a, 23b) to readily conform to the expansion and contraction of the cover portion 31 in the direction perpendicular to the stacking direction, and causes the direction of stress applied at the interface between the via conductor 23 (23a, 23b) and the cover portion 31 to be distributed on the surface of the cover portion 31.

The thickness of the flange 232, that is, dimension A3 in the stacking direction, is more preferably 0.1 um or more and 1.0 μm or less, and even more preferably 0.1 μm or more and 0.5 μm or less. When A3 is 0.1 μm or more, delamination at the interface between the via conductor 23 (23a, 23b) and the cover portion 31 is significantly suppressed. Meanwhile, when A3 is 1.0 μm or less, the reduction in flange strength is suppressed.

Dimension D5 of the flange 232 in the direction perpendicular to the stacking direction is more preferably 101% or more and 150% or less of dimension D1 described above, that is, the dimension perpendicular to the stacking direction at the surface of the cover portion 31, and even more preferably 101% or more and 120% or less. When D5 is 101% or more of D1, delamination at the interface between the via conductor 23 (23a, 23b) and the cover portion 31 is significantly suppressed. Meanwhile, when D5 is 150% or less of D1, the distance between conductors with different polarity is maintained while suppressing degradation of electrical insulation.

The following process is used to determine whether a flange 232 has been formed at the end portion of the via conductor 23 (23a, 23b) on the mounting face 11 side and to determine dimensions A3 and D5 of the flange 232. First, using the process to determine D1, D2, D3, and A1 above an image is obtained of the interface between the via conductor 23a and the ceramic layers 21, as well as the mounting face 11 and the opposite face in the same field of view, as shown in FIG. 8, and line segments v₁, v₂, and h₁ are drawn in the image. Next, the intersection of line segment v₁ with line segment h₁ is set as e₅₁ and the intersection of line segment v₂ with line segment h₁ is set as e₅₂. Next, in the image, it is determined that a flange 232 has been formed in the end portion of the via conductor 23a on the mounting face 11 side when a portion of the via conductor 23a is present on the opposite side of the stack 20 with respect to the line segment h₁, and a portion of the via conductor 23a is present both to the outside of point e₅₁ with respect to the axis of the via conductor 23a and to the outside of point e₅₂ with respect to the axis of the via conductor 23a, along line segment h₁. Note that while the end portion of the via conductor 23a on the mounting face 11 side is connected to the terminal electrode 40a, it is easy to distinguish between the two because of the difference in contrast in the microscopic image between the via conductor 23a and the terminal electrode 40a. Next, in the image, a line segment h₅ is drawn on the side opposite the stack 20 to line segment h₁, that is, the side of the via conductor 23a from which the flange 232 protrudes, that is parallel to line segment h₁, contacts the via conductor 23a, and is the maximum distance from line segment h₁. The value obtained by dividing the distance between line segment h₁ and line segment h₅ by the magnification factor of the microscopic image is A3. Next, in the image, line segment v₇ is drawn to the outside of point e₅₁ relative to the axis of the via conductor 23a that is perpendicular to line segment h₁, in contact with the via conductor 23a, and at the greatest distance from point e₅₁, and line segment v₈ is drawn to the outside of point e₅₂ relative to the axis of the via conductor 23a that is perpendicular to line segment h₁, in contact with the via conductor 23a, and at the greatest distance from point e₅₂. The distance between line segment v₇ and line segment v₈ is then divided by the magnification factor of the microscopic image, and the resulting value is set as D5.

### Terminal Electrodes

The material of the terminal electrodes 40 (40a, 40b) is not limited as long as the material has electrical conductivity. Examples of materials include metals such as nickel (Ni), copper (Cu), tin (Sn), palladium (Pd), platinum (Pt), silver (Ag), and gold (Au), alloys containing any of these as the main component, and electrically conductive resins.

The terminal electrodes 40 (40a, 40b) may be composed of a base conductor 41 in contact with the element body 10 and a plated conductor 42 formed on the surface of the base conductor 41. Terminal electrodes 40 (40a, 40b) with this structure can improve adhesion of the element body 10 with the base conductor 41, and improve the solder wettability when mounted on the circuit board using the plated conductor 42.

An example of a material for the base conductor 41 is Ni. The thickness of the base conductor 41 can be 0.1 μm or more and 10 μm or less, and is preferably 0.5 μm or more and 5 μm or less.

The plated conductor 42 may be formed with a single layer or with multiple layers. When multiple layers are formed in the plated conductor 42, two to four layers is preferred. In one example of the materials and structure of the plated conductor 42, a structure is formed in the order Cu, Ni, and Sn. The thickness of the plated conductor 42 can be 1 μm or more and 20 μm or less, and 3 μm or more and 10 μm or less is preferred.

### Second Embodiment

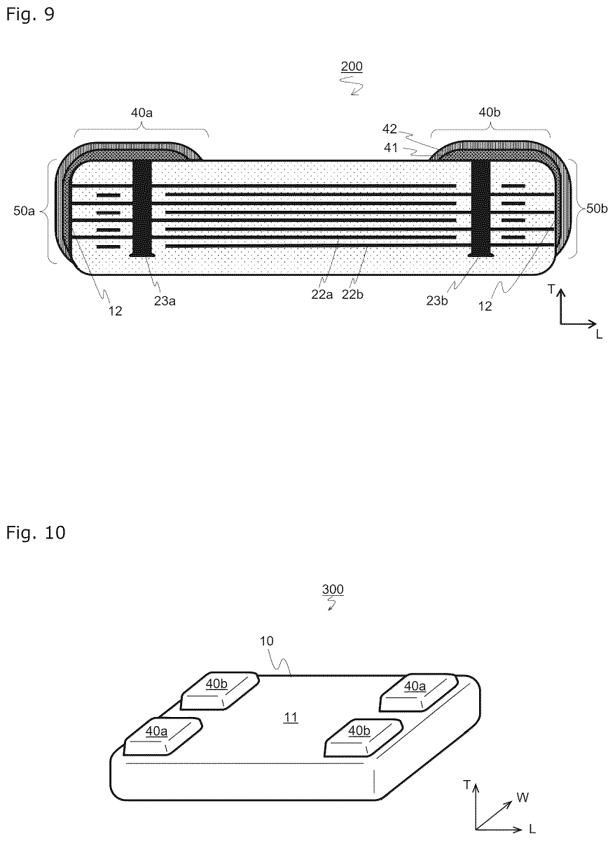

In another embodiment (second embodiment) of the multilayer ceramic capacitor in the first aspect of the invention, the internal electrodes are drawn out on a face perpendicular to the mounting face, and external electrodes are placed on the face from which the internal electrodes are drawn out (drawn-out face), so that the internal electrodes are electrically connected to each other via the external electrodes. An example of a multilayer ceramic capacitor 200 in the second embodiment is shown in FIG. 9. FIG. 9 shows an example in which two faces opposite each other are used as drawn-out faces 12, but the number of drawn-out faces is not limited to this example. FIG. 9 shows an example of terminal electrodes 40 (40a, 40b) extending to drawn-out face 12 forming external electrodes 50 (50a, 50b), but external electrodes 50 (50a, 50b) may be formed separately from terminal electrodes 40 (40a, 40b). In the multilayer ceramic capacitor 200, the current flowing through the internal electrodes 22 (22a, 22b) is divided between via conductors 23 (23a, 23b) and external electrodes 50 (50a, 50b), resulting in smaller current flowing through individual via conductors 23 (23a, 23b) and external electrodes 50 (50a, 50b). This reduces heat generation during operation.

### Third Embodiment

In another embodiment (the third embodiment) of the multilayer ceramic capacitor in the first aspect of the invention, the number of terminal electrodes located on the mounting face is four or more, and each terminal electrode has a different polarity from the terminal electrodes that are closest to it on the mounting face. An example of the third embodiment of a multilayer ceramic capacitor 300 is shown in FIG. 10. While FIG. 10 shows an example in which the number of terminal electrodes 40 arranged on the mounting face 11 is four, the number of terminal electrodes arranged on the mounting face is not limited to this example. Because the multilayer ceramic capacitor 300 is configured so that the direction of the current flowing through the via conductors (not shown) electrically connected to each terminal electrode 40 (40a, 40b) is in the opposite direction between conductors that are nearest to each other, the magnetic fields generated by the current cancel each other out, reducing the equivalent series inductance (ESL). These effects are more pronounced when the multilayer ceramic capacitor 300 has a mounting face 11 that is nearly square in shape, that is, when the value of W/L, which is the ratio of W to L, is between 0.8 and 1, where, among the two faces parallel to the stacking direction of the stack and facing each other, one spacing, or dimension in the L direction, is L μm, and the other spacing, or dimension in the W direction, is W μm (provided L≥W).

### Method for Manufacturing Multilayer Ceramic Capacitor

A multilayer ceramic capacitor in the first aspect of the present invention can be manufactured by the procedure described below.

### (A) Preparation of Ceramic Powder

First, the ceramic powder is prepared. Commercially available ceramic powders can be used if appropriate. When the ceramic powder is prepared by the user, raw powder materials including their constituent elements are mixed at a predetermined ratio and pre-fired (provisionally fired). Additives such as the additive elements and firing aids may be added when mixing the raw powder materials at predetermined ratios, or the additives may be added to the powder after provisional firing.

### (B) Preparation of the Green Sheet

Next, the ceramic powder is mixed with a binder and dispersant to prepare a slurry, which is then formed into a sheet to obtain a green sheet.

The binder used should be one that can maintain the shape of the green sheet, and that can volatilize without leaving behind carbon or other residues in the binder removal step prior to firing. Examples of binders that can be used include polyvinyl alcohol-based, polyvinyl butyral-based, cellulose-based, urethane-based, and vinyl acetate-based binders. The amount of binder used is not limited, but since it is removed in a subsequent step, the amount of binder used is preferably minimized to the extent that the desired moldability and shape retention can be obtained, in order to reduce raw material costs.

The dispersant used should be one that can keep the previously fired powder and the binder from agglomerating and should be easily removed by volatilization or other means after formation of the green sheet described below. Examples of dispersants that can be used include water and alcohol-based solvents.

Components that adjust the properties of the slurry, such as dispersants, plasticizers, and thickeners, may be added to the slurry.

The method used to mix the mixed powder with the binder and dispersant is not limited as long as each component is uniformly mixed and impurities are kept from being mixed in. One example is ball mill mixing.

Methods that can be used to form the prepared slurry into a sheet to obtain a green sheet include any method common in the art, such as the doctor blade method and the die coating method.

### (C) Formation of the Internal Electrode Pattern

Next, an internal electrode pattern containing metal is formed on the green sheet. The internal electrode pattern can be formed by printing or coating internal electrode paste in a predetermined pattern, or by forming a metal film in a predetermined pattern by vapor deposition or sputtering deposition. The internal electrode pattern should be formed leaving a sufficient margin to ensure electrical insulation where there is no contact with the via conductor pattern formed later.

When forming an internal electrode pattern using an internal electrode paste, the internal electrode paste is obtained by mixing metal particles with a vehicle in a three-roll mill. In addition to the components mentioned above, the internal electrode paste may also contain glass frit or ceramic powder.

The type and amount of binder and solvent included in the vehicle are not limited, and are preferably selected as appropriate after taking into consideration the viscosity of the internal electrode paste, ease of handling, and compatibility with the green sheet.

Printing of the internal electrode paste on the raw sheet can be performed, for example, using a screen mask with a predetermined internal electrode pattern. During printing, a space, that will become the margin portion when made into a multilayer ceramic capacitor, can be left.

### (D) Preparation of the Green Stack

Next, green sheets with internal electrode patterns are stacked in a predetermined number of layers, and the green sheets are pressure-bonded to obtain a green stack. Stacking and pressure bonding can be performed using any method common in the art, such as pressing the stacked green sheets together in the stacking direction while heating, and thermo-compression bonding the green sheets together by the action of the binder.

When performing stacking and pressure bonding, a green sheet may be added to the end in the stacking direction to serve as a cover portion when made into a multilayer ceramic capacitor. At this time, the green sheet that is added may have the same or a different composition from the green sheets on which an internal electrode pattern has been printed. From the standpoint of matching the shrinkage rate during firing, the composition of the green sheet that is added is preferably the same or similar to the composition of the green sheets on which the internal electrode precursors have been arranged.

### (E) Formation of Through-Holes for Via Conductors

Next, through holes for via conductors are formed in the green stack. Conventional methods such as a drill or laser can be used to form the holes. Among these, the use of a laser is preferred because of its ability to form smooth machined surfaces. After the through-holes have been formed, a portion of the material forming the green stack is removed from the peripheral edge of one of the openings to form a void with a shape corresponding to a flange. Examples of methods used to removing the green sheet include pressing a mold with a protruding portion against the peripheral edge of the opening and grinding.

### (F) Filling With Via Conductive Paste

Next, the through-holes are filled with conductive paste to form a via conductor pattern. Conventional methods such as injection using a syringe or printing using a metal mask can be adopted to fill the holes with conductive paste. Among these, printing with a metal mask is preferred because of its superiority in terms of filling small-diameter holes. As for the components of the conductive paste, they may be the same as those in the paste for internal electrodes, and the amount of each component should be determined after taking into consideration their hole filling properties. When forming a cavity in the end portions of the via conductor located inside the cover portion, a protruding member with dimensions smaller than the through-holes may be inserted from the side on which the cavity is formed before the through-holes are filled with the conductive paste and then the protruding member is removed, or the green stack may be subjected to vibration with the side in which the cavities being formed facing up after filling the through-holes with conductive paste. If the end portions of the via conductors located inside the cover portion are to be shaped so that the central portion bulges out, the conductive paste should be filled so that it protrudes (rises) beyond the surface height of the green stack on the end portion side. When a flange is formed in the end portions that reach the surface of the cover portion to protrude in the stacking direction beyond the surface of the cover portion and extends outward with respect to the axis of the via conductors, after placing a masking material having an opening larger in terms of size than the opening in the through-holes, conductive paste is used to fill the openings in the masking material as well as the through-holes, and the masking material is removed.

### (G) Pressure Bonding of the Cover Portion Sheet

Next, a green sheet that will become the cover portion when the multilayer ceramic capacitor is made is pressure bonded on the surface positioned on the side from which a portion of the material forming the green stack was removed from the peripheral edges of the through-hole openings in (E), among the surfaces perpendicular to the stacking direction of the green stack. The green sheet to be pressure bonded may have the same composition as the green sheets forming the green stack or may have a different composition. Examples of pressure bonding methods include pressing using a mold or the application of pressure using a roller.

### (H) Formation of the Terminal Electrode Pattern

Next, a terminal electrode pattern is formed on at least one of the faces (mounting face) perpendicular to the stacking direction of the stack. The terminal electrode pattern can be formed by printing or applying terminal electrode paste or by forming a metal film by vapor deposition or sputtering deposition. The terminal electrode pattern may be formed using a mask with a predetermined pattern, or may be formed out of a paste film or metal film on the entire mounting face of the green stack, by removing the portions outside of the terminal electrode pattern. Face milling and barrel polishing can be used to remove the portions outside of the terminal electrode pattern. When terminal electrode paste is used to form the terminal electrode pattern, the same components in the internal electrode paste described above can be used, and the amount of each component is determined so that a uniform pattern can be obtained with a predetermined thickness.

### (I) Preparing Pre-Fired Chips

Next, the green stack is separated into units in the shape of individual multilayer ceramic capacitors to obtain chips prior to firing. Means commonly used to separate a green stack into individual capacitors include dicing saws and laser cutting machines. After the green stack has been separated into units to form a face on which the internal electrode precursor is exposed, the face may be coated with a material for forming a margin portion to complete the pre-fired chips.

### (J) Removing the Binder

The resulting pre-fired chips are then heated to volatilize and remove the binder. Heating conditions should be set as appropriate after taking into consideration the amount and volatilization temperature of the binder. One example is to hold temperatures from 200° C. to 500° C. for 5 to 20 hours in a nitrogen (N₂) atmosphere.

### (K) Firing the Pre-Fired Chips

Next, the pre-fired chips with the binder removed are heated to a predetermined temperature for firing. When setting the firing conditions, the firing properties of the ceramic powder and the heat and oxidation resistance of the metals in the internal electrode pattern, via conductor pattern, and terminal electrode pattern are preferably taken into consideration. Examples of firing conditions include holding the chips at 1100° C. to 1400° C. for 10 minutes to 2 hours in a reducing atmosphere of nitrogen (N₂), hydrogen (H₂), and water vapor (H₂O). After firing, re-oxidation treatment may be performed in a nitrogen (N₂) gas atmosphere or in a low-oxygen atmosphere kept at 600° C. to 1000° C.

The fired body thus obtained may be used as a multilayer ceramic capacitor as is, or it may be used as a multilayer ceramic capacitor after a conductive layer has been formed on the surface of the terminal electrode pattern by plating.

### Circuit Board

The circuit board in the second aspect of the invention has a mounted multilayer ceramic capacitor in the first aspect. This circuit board can be reliably installed in a small space because the multilayer ceramic capacitor is thin and suppresses the decrease in electrostatic capacitance.

The following technologies are also disclosed in the present specification.

### Addendum 1

A multilayer ceramic capacitor, comprising:
a cuboid element body having
   a stack formed with alternating ceramic layers and internal electrodes made primarily of metal,
   a protective portion covering a surface of the stack, and
   a plurality of via conductors arranged so as to pass through the ceramic layers in the stacking direction of the stack, electrically connected to the internal electrodes, and having one end reaching the surface of the protective portion while the other end is positioned in the protective portion, and
a plurality of terminal electrodes arranged on the surface of the element body and electrically connected to the end of each via conductor reaching the surface of the protective portion, wherein the ends of the via conductors positioned in the protective portion form a flange that extends outwardly relative to the axis of the via conductor.

### Addendum 2

The multilayer ceramic capacitor according to (Addendum 1), wherein the via conductors satisfy D1>D2, where in a cross-section parallel to the stacking direction, D1 is the dimension perpendicular to the stacking direction at the surface of the protective portion, and D2 is the minimum dimension perpendicular to the stacking direction inside the protective portion on the opposite side of the protective portion relative to the stack and the end portions of the via conductors are located inside, and the dimension in the direction perpendicular to the stacking direction decreases monotonically from D1 to reach D2.

### Addendum 3

The multilayer ceramic capacitor according to (Addendum 2), wherein the via conductors satisfy D3≥D1, where in a cross-section parallel to the stacking direction, D3 is the dimension in the direction perpendicular to the stacking direction of the flange formed by the end portion inside the protective portion.

### Addendum 4

The multilayer ceramic capacitor according to any of (Addendum 1) to (Addendum 3), wherein dimension A1 of the via conductors in the stacking direction of the flange is 0.1 μm or more and 10 μm or less.

### Addendum 5

The multilayer ceramic capacitor according to any of (Addendum 1) to (Addendum 4), wherein the via conductors have a cavity opening in the end portion inside the protective portion.

### Addendum 6

The multilayer ceramic capacitor according to any of (Addendum 1) to (Addendum 5), wherein the via conductors have an end portion reaching the surface of the protective portion that protrudes in the stacking direction beyond the surface of the protective portion and forms a flange that extends outward relative to the axis of the via conductor.

### Addendum 7

The multilayer ceramic capacitor according to any of (Addendum 1) to (Addendum 6), wherein the dimension in the stacking direction is less than 100 μm.

### Addendum 8

A circuit board carrying the multilayer ceramic capacitor according to any of (Addendum 1) to (Addendum 7).

### Industrial Applicability

The present invention is able to provide a thin multilayer ceramic capacitor with suppressed electrostatic capacitance degradation. In addition to being highly reliable, such multilayer ceramic capacitors can be placed in small spaces, and so are useful in terms of placing fewer restrictions on circuit board design.
Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A multilayer ceramic capacitor, comprising:
a cuboid element body having
a stack formed with alternating ceramic layers and internal electrodes made primarily of metal,
a protective portion covering a surface of the stack, and
a plurality of via conductors arranged so as to pass through the ceramic layers in the stacking direction of the stack, electrically connected to the internal electrodes, and having one end reaching the surface of the protective portion while the other end is positioned in the protective portion, and
a plurality of terminal electrodes arranged on the surface of the element body and electrically connected to the end of each via conductor reaching the surface of the protective portion, wherein the ends of the via conductors positioned in the protective portion form a flange that extends outwardly relative to the axis of the via conductor.

2. The multilayer ceramic capacitor according to claim 1, wherein the via conductors satisfy D1>D2, where in a cross-section parallel to the stacking direction, D1 is the dimension perpendicular to the stacking direction at the surface of the protective portion, and D2 is the minimum dimension perpendicular to the stacking direction inside the protective portion on the opposite side of the protective portion relative to the stack and the end portions of the via conductors are located inside, and the dimension in the direction perpendicular to the stacking direction decreases monotonically from D1 to reach D2.

3. The multilayer ceramic capacitor according to claim 2, wherein the via conductors satisfy D3≥D1, where in a cross-section parallel to the stacking direction, D3 is the dimension in the direction perpendicular to the stacking direction of the flange formed by the end portion inside the protective portion.

4. The multilayer ceramic capacitor according to claim 1, wherein dimension A1 of the via conductors in the stacking direction of the flange is 0.1 μm or more and 10 μm or less.

5. The multilayer ceramic capacitor according to claim 1, wherein the via conductors have a cavity opening in the end portion inside the protective portion.

6. The multilayer ceramic capacitor according to claim 1, wherein the via conductors have an end portion reaching the surface of the protective portion that protrudes in the stacking direction beyond the surface of the protective portion and forms a flange that extends outward with relative to the axis of the via conductor.

7. The multilayer ceramic capacitor according to claim 1, wherein the dimension in the stacking direction is less than 100 μm.

8. A circuit board carrying the multilayer ceramic capacitor according to claims 1.
